(19) United States
(12) Patent Application Publication
(10) Pub. No.: US 2005/0175319 A1
(43) Pub. Date: Aug. 11, 2005

(54) Method and device for real-time capturing streaming video/audio

(75) Inventor: Yung-Tien Kuo, Hsinchu City (TW)

Correspondence Address: BRUCE H. TROXELL;SUITE 1404, 5205 LEESBURG PIKE, FALLS CHURCH, VA, 22041, US

(73) Assignee: Infineon-ADKtek Co., Ltd.

(21) Appl. No.: 11/041,977

(22) Filed: Jan. 26, 2005

(30) Foreign Application Priority Data
Feb. 6, 2004 (TW) 93102713

(51) Int. Cl. G11B 27/00

(52) U.S. Cl. 386/54

(57) ABSTRACT

A method and device for real-time capturing streaming AV with respect to the perception of a user is disclosed. The method of the invention comprises the steps of: registering a segment of streaming AV being played; and capturing an instant frame from the registered segment with respect to a specified reaction time as the user perceives the frame and conducts a capturing operation, such that a correct image can be save disregarding the time lag between the time of the user perceiving an imagine to be saved and the real time of a capturing operation being conducted.

### FIELD OF THE INVENTION

The present invention relates to a method and device for real-time capturing streaming AV (audio and video) data with respect to the perception of a user, and more particularly, to a method and device for capturing streaming AV data with respect to the perception of a user through registering a segment of steaming AV data.

### BACKGROUND OF THE INVENTION

So far, most of electronic products are adapted for receiving and playing digitized data. For instance, as video signals are digitized, a digital TV such as a PDP TV, a LCD TV, and so on, is capable of displaying the digitized video signals in a manner of less distortion while comparing with the conventional TV. Therefore, users gradually choose the digital TVs instead of conventional TVs for having images of higher definition and better quality.

When a user watches digital TV, it is easy for the user to store an unprotected program into a data storage media, such as a VCD recorder, a DVD recorder, and so on. However, for protecting the copyright of a program, the digital TV program provider employs video streaming as input of the digital TV so as to preventing the program from being copied.

However, it is fine that when a user only wants to save an instant frame of the streaming AV being displayed by the digital TV. To achieve this objective, it is common to use a video capturing device or the like for saving the instant frame at a picture format.

Nevertheless, the minute when the user perceives to save the instant frame, it takes times for his brain to direct his finger to press the save button of the video capturing device, and thus miss the intended frame since he can not react in real time. Therefore, the saved picture is not the one that the user really wants to save.

Owing to the above description, it is desired to provide a method and device for real-time capturing streaming AV with respect to the perception of a user.

### SUMMARY OF THE INVENTION

It is the primary object of the present invention to provide a method for real-time capturing streaming AV with respect to the perception of a user, comprising the steps of: registering a segment of streaming AV being played; and capturing an instant frame from the registered segment with respect to a specified reaction time as the user perceives the frame and conducts a capturing operation.

In a preferred embodiment of the present invention, the method further includes the steps of: determining the length of the segment of the streaming AV to be registered, i.e. the amount of frames, in accordance with the reaction time. For example, the amount of frames to be registered can be between 1 to 30 frames while not including the frame being displayed at the real time of the capturing operation being conducted.

It is another object of the present invention to provide a device for real-time capturing streaming AV respect to the perception of a user, comprising: a register, for registering a segment of streaming AV being played.

In a preferred embodiment of the present invention, the device further comprises: a receiver, for receiving streaming AV data; a decoder, for receiving and decoding the streaming AV data outputted from the receiver while outputting the decoded streaming AV data to a display; and a controller, for capturing a segment of the decoded streaming AV data outputted from the decoder and directing the segment to the register for registering; wherein the amount of frames included in the segment is determined with respect to a reaction time of the user while the reaction time is defined as a period of time counted between the time of the user perceiving an imagine to be saved and the real time of a capturing operation being conducted.

In addition, the device further comprises a memory for storing a frame of the registered segment outputted from the register. The controller captures an instant frame from the register with respect to the perception of the user and stores the same to the memory. The device further comprises a remote control for enabling the user conduct the capturing operation remotely.

To sum up, the present invention provides a method and device for capturing streaming AV data with respect to the perception of a user through registering a segment of steaming AV data, such that a correct image can be save disregarding the time lag between the time of the user perceiving an imagine to be saved and the real time of a capturing operation being conducted.

Other objects, advantages and novel features of the present invention will be drawn from the following detailed embodiment of the present invention with attached drawings, in which:

### BRIEF DESCRIPTION OF THE DRAWINGS

FIG. 1 is a schematic illustration showing a method for real-time capturing streaming AV data with respect to the perception of a user according to the present invention; and

FIG. 2 is a schematic diagram showing a device for real-time capturing streaming AV data with respect to the perception of a user according to the present invention.

### DESCRIPTION OF THE PREFERRED EMBODIMENT

When a user perceives to save an instant frame of streaming AV data being displayed by a digital TV or a PC display, in general he conducts to capture the instant frame after reaction of his brain for directing his finger to press a save button of a capturing device. That is, when the user perceives to save the instant frame, he need some reaction time to conduct the capturing operation and so he cannot really save the instant frame he perceives to save. Therefore, if a segment of the streaming AV data is registered when the streaming AV data is being displayed, the instant frame that a user perceives can be captured correctly from the registered frames when the user perceives and conducts the capturing operation.

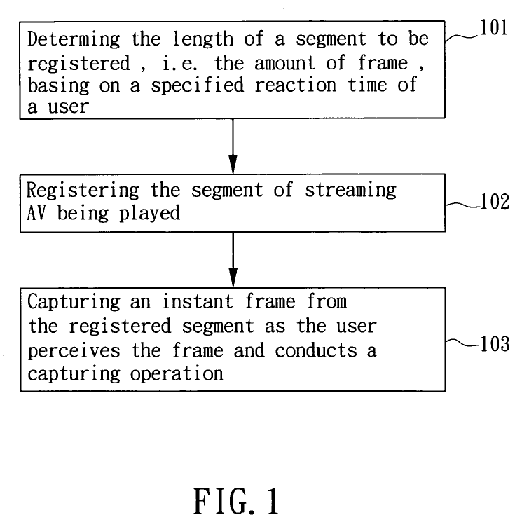

FIG. 1 is a schematic illustration showing a method for real-time capturing streaming AV data with respect to the perception of a user according to the present invention. Firstly, as disclosed in step 101, an amount of frames to be registered of streaming AV being played is determined with respect to a reaction time of the user, and then the flow proceeds to step 102. At step 102, the segment including the amount of frames to be registered, which can be between 1 frame to 30 frames, is registered in an register of an image capturing device, and then the flow proceeds to step 103. At step 103, an instant frame is captured from the registered segment with respect to a specified reaction time as the user perceives the frame and conducts a capturing operation.

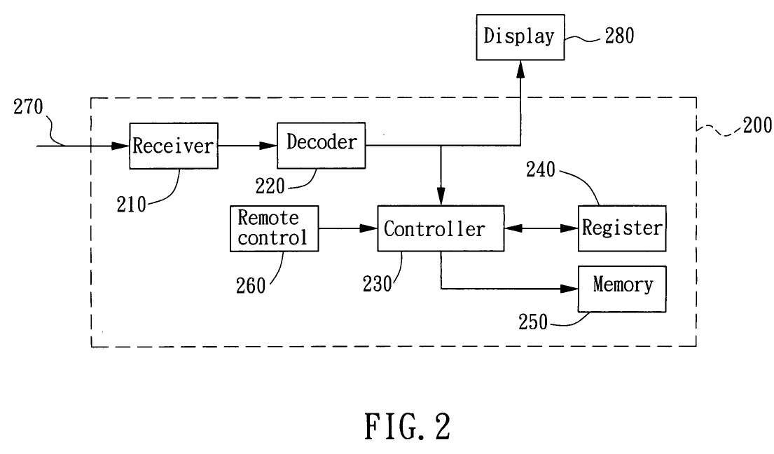

In accordance with the method of the present invention, a device for real-time capturing streaming AV data with respect to the perception of a user is also provided. FIG. 2 is a schematic diagram showing a device for real-time capturing streaming AV data with respect to the perception of a user according to the present invention. As seen in FIG. 2, a capturing device 200 comprises a receiver 210, a decoder 220, a controller 230, a register 240, a memory 250 and a remote control 260.

The receiver 210 receives digital streaming AV data 270 and outputs the same to the decoder 220 for decoding. The decoded data is then outputted from the decoder 220 to a display 280 for displaying. The controller 230 of the capturing device 200 captures a segment of the streaming AV data 270 outputted from the decoder 220 (which includes more than 1 frame or has an amount of frame determined basing on a specified reaction time) and directs the captured segment to be saved in the register 240. It is noted that the registered segment of the streaming AV data is updated continuously along with the streaming AV 270 being played on the displayer by the control of the controller 230, that is, the frames of the segment registered in the register 240 is proximate and prior to the instant frame of the streaming AV data 270 which is being displayed by the display 280.

The memory 250 is for storing a frame of the streaming AV data outputted from the register. The controller 230 captures the instant frame from the register 240 with respect to a specified reaction time of the user and stores the captured frame in the memory 250.

Therefore, when a user watches TV having the display 280 to display the streaming AV data 270 and wants to use the remote control 260 to control the capturing device 200 to capture the instant frame of the streaming AV data 270 being displayed by the display 280, after the user presses a button of the remote control 260, the remote control 260 commands the controller 230 to capture a frame from the register 240 in accordance with the reaction time of the user.

Thus, through the method and device for real-time capturing streaming AV data with respect to the perception of a user of the present invention, a user can capture the exact instant frame that he perceives.

As mentioned above, through registering a segment of the streaming AV data including frames proximate and prior to the instant frame of the streaming AV data being displayed, the method and device for real-time capturing streaming AV data with respect to the perception of a user of the present invention can capture the exact instant frame that a user perceives from the streaming AV data being played.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A method for real-time capturing streaming AV data with respect to the perception of a user, comprising the steps of:
registering a segment of streaming AV data being displayed in real time; and
capturing a frame from the registered segment with respect to a specified reaction time as the user perceives the frame and conducts a capturing operation.

2. The method as claimed in claim 1, further comprising a step of:
determining the length of the segment to be registered in accordance with the specified reaction time.

3. The method as claimed in claim 1, further comprising a step of:
determining the mount of frames included in the segment in accordance with the specified reaction time.

4. The method as claimed in claim 3, wherein the mount of frames is between 1 frame to 30 frames.

5. The method as claimed in claim 3, wherein the registered segment is prior to the instant frame of the streaming AV data being displayed.

6. A device for real-time capturing streaming AV data with respect to the perception of a user, comprising:
a register, for registering a segment of streaming AV data being displayed and outputting the same.

7. The device as claimed in claim 6, further comprising:
a receiver, for receiving streaming AV data;
a decoder, for receiving and decoding the streaming AV data outputted from the receiver while outputting the decoded streaming AV data to a display; and
a controller, for capturing a segment of the decoded streaming AV data outputted from the decoder and directing the segment to the register for registering;
wherein the amount of frames included in the segment is determined with respect to a reaction time of the user while the reaction time is defined as a period of time counted between the time of the user perceiving an imagine to be saved and the real time of a capturing operation being conducted.

8. The device as claimed in claim 7, further comprising:
a memory, for storing a frame of the segment registered in the register, wherein the controller captures the frame from the register with respect to the perception of the user and stores the same to the memory.

9. The device as claimed in claim 7, further comprising:
a remote control, for enabling the user conduct the capturing operation remotely.
